(19) United States
(12) Patent Application Publication
(10) Pub. No.: US 2026/0290691 A1
(43) Pub. Date: Sep. 24, 2026

(54) DIELECTRIC CERAMIC COMPOSITION AND MULTILAYER CERAMIC ELECTRONIC COMPONENT

(71) Applicant: TDK Corporation, Tokyo (JP)

(72) Inventors: Ryota NAMIKI, Tokyo (JP); Toshihiro IGUCHI, Tokyo (JP); Yutaka SUWAZONO, Tokyo (JP); Yasuhiro ITO, Tokyo (JP)

(73) Assignee: TDK Corporation, Tokyo (JP)

(21) Appl. No.: 19/567,665

(22) Filed: Mar. 16, 2026

(30) Foreign Application Priority Data
Mar. 19, 2025 (JP) 2025-045496

(51) Int. Cl. H01G 4/12; H01G 4/30

(52) U.S. Cl. CPC H01G 4/1209; H01G 4/30

(57) ABSTRACT

A dielectric ceramic composition includes main phase grains and a grain boundary. The main phase grains contain a perovskite-type compound containing at least Ca and Zr. The dielectric ceramic composition contains at least one selected from the group consisting of V, Nb, Ta, and W as Z1. The total content of Z1 is 0.005 parts by mole or more and 1.2 parts by mole or less. At least a part of the main phase grains is composed of specific main phase grains. Each of the specific main phase grains includes a first microscopic region and a second microscopic region, at least a part of the first microscopic region is located at an outer peripheral portion, at least a part of the second microscopic region is located at a central portion, and a content of Z1 in the second microscopic region is lower than that in the first microscopic region.

### TECHNICAL FIELD

The present disclosure relates to a dielectric ceramic composition and a multilayer ceramic electronic device.

### BACKGROUND

Patent Document 1 discloses a reduction-resistant dielectric ceramic composition and a multilayer ceramic capacitor formed by alternately laminating ceramic sheets formed from the reduction-resistant dielectric ceramic composition and electrodes.

### Patent Document

Patent Document 1: JP Patent Application Laid Open No. 2007-091588

### SUMMARY

A dielectric ceramic composition according to the present disclosure contains:
main phase grains and a grain boundary existing between the main phase grains,
wherein the main phase grains contain a perovskite-type compound as a main component,
the perovskite-type compound contains at least Ca as an A-site element and at least Zr as a B-site element,
the dielectric ceramic composition further contains at least one selected from the group consisting of V, Nb, Ta, and W as a first additive element Z1,
the total content of Z1 with respect to 100 parts by mole of the B-site element is 0.005 parts by mole or more and 0.80 parts by mole or less,
at least a part of the main phase grains is composed of specific main phase grains,
each of the specific main phase grains includes a first microscopic region and a second microscopic region, at least a part of the first microscopic region is located at an outer peripheral portion, at least a part of the second microscopic region is located at a central portion, and a content of the first additive element Z1 with respect to 100 parts by mole of the B-site element in the second microscopic region is lower than that in the first microscopic region.

### BRIEF DESCRIPTION OF THE DRAWINGS

FIG. 1 is a schematic view illustrating a cross-section of a multilayer ceramic capacitor according to an embodiment of the present disclosure;

FIG. 2 is a HAADF image of a dielectric ceramic composition according to the embodiment of the present disclosure;

FIG. 3 is a HAADF image obtained by enlarging a part of FIG. 2;

FIG. 4 is a schematic view illustrating a result of line analysis; and

FIG. 5 is a schematic view illustrating a result of line analysis.

### DETAILED DESCRIPTION

An object of the present disclosure is to obtain a dielectric ceramic composition capable of providing a multilayer ceramic electronic device having excellent reliability while maintaining satisfactory temperature characteristics.

In the dielectric ceramic composition according to the present disclosure, a content of Z1 contained in the first microscopic region may be 0.08 parts by mole or more in terms of oxide, with respect to 100 parts by mole in terms of oxide of the total content of all elements contained in the first microscopic region, and
a content of Z1 contained in the second microscopic region may be less than 0.08 parts by mole in terms of oxide, with respect to 100 parts by mole in terms of oxide of the total content of all elements contained in the second microscopic region.

The dielectric ceramic composition according to the present disclosure may further contain at least one selected from the group consisting of Mn and Cr, Si, and Al as a second additive element Z2.

In the dielectric ceramic composition according to the present disclosure, the total content of Z2 with respect to 100 parts by mole of the B-site element may be 1.8 parts by mole or more and 7.0 parts by mole or less.

In the dielectric ceramic composition according to the present disclosure, the total content of Mn and Cr in the dielectric ceramic composition may be more than a content of Si, and a content of Si in the grain boundary may be more than the total content of Mn and Cr.

In the dielectric ceramic composition according to the present disclosure, the total content of Ti, Mn, Cr, and Z1 with respect to 100 parts by mole of the B-site element may be 8.0 parts by mole or less.

In the dielectric ceramic composition according to the present disclosure, the total content of Mn, Cr, and Z1 contained in the first microscopic region may be 0.5 parts by mole or more in terms of oxide, with respect to 100 parts by mole in terms of oxide of the total content of all elements contained in the first microscopic region, and
the total content of Mn, Cr, and Z1 contained in the second microscopic region may be less than 0.5 parts by mole in terms of oxide, with respect to 100 parts by mole in terms of oxide of the total content of all elements contained in the second microscopic region.

In the dielectric ceramic composition according to the present disclosure, the first microscopic region may extend from the grain boundary toward the center of the specific main phase grain by a distance of at least one-fourth of an equivalent circle radius.

In the dielectric ceramic composition according to the present disclosure, a ratio of the number of the specific main phase grains to the number of the main phase grains may be 10% or more and 95% or less.

In the dielectric ceramic composition according to the present disclosure, an area ratio of the first microscopic region in any cross-section may be 20% or more and 95% or less.

The dielectric ceramic composition according to the present disclosure may further contain at least one selected from the group consisting of Mg, Li, B, and P as a third additive element Z3.

In the dielectric ceramic composition according to the present disclosure, an average grain size of the main phase grains may be 0.5 μm or more and 3.0 μm or less.

According to another aspect of the present disclosure, there is provided a multilayer ceramic electronic device containing the dielectric ceramic composition according to the aspect.

Hereinafter, the present disclosure will be described based on specific embodiments.

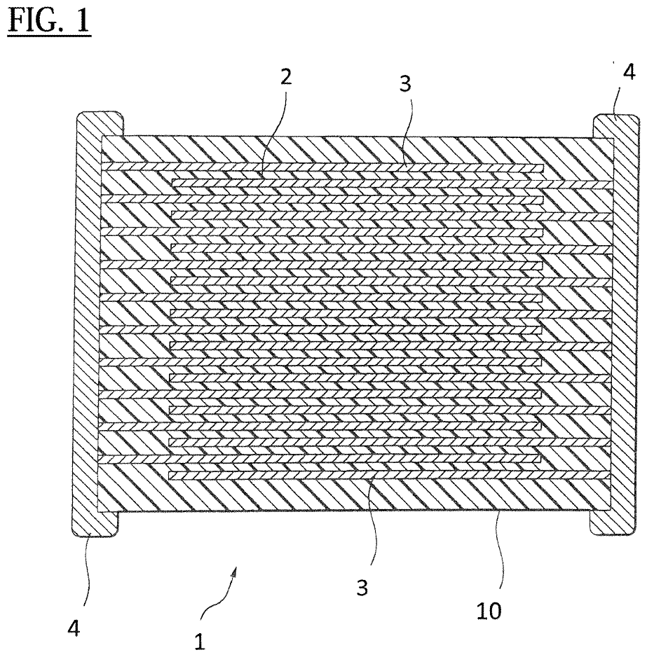

As an example of an electronic component according to the present embodiment, a multilayer ceramic capacitor 1 is illustrated in FIG. 1. The multilayer ceramic capacitor 1 includes an element body 10 having a configuration in which dielectric layers 2 and inner electrode layers 3 are laminated alternately. A pair of outer electrodes 4, which are electrically connected to the inner electrode layers 3 disposed alternately at the inside of the element body 10, are formed at both ends of the element body 10. A shape of the element body 10 is not particularly limited, but the shape is typically set to a rectangular parallelepiped shape. In addition, dimensions of the element body 10 are also not particularly limited, and may be set to appropriate dimensions depending on applications.

The dielectric layers 2 consist of a dielectric ceramic composition according to the present embodiment to be described later. The thickness (interlayer thickness) of each of the dielectric layers 2 is not particularly limited, and can be arbitrarily set depending on desired characteristics, applications, and the like. Typically, the interlayer thickness may be 100 μm or less, or may be 30 μm or less. In addition, the number of the laminated dielectric layers 2 is not particularly limited, but in the present embodiment, the laminating number may be, for example, 20 or more.

The inner electrode layers 3 are laminated such that respective cross-sections are alternately exposed to surfaces of the two facing ends of the element body 10.

A main component of a conductive material contained in each of the inner electrode layers 3 is a metal. The metal is not particularly limited, and for example, a conductive material known as a metal such as Pd, a Pd-based alloy, Pt, a Pt-based alloy, Ni, a Ni-based alloy, Cu, or a Cu-based alloy may be used. The metal may contain various minor components such as P, S, and Cl, each in an amount of approximately 0.1 mass % or less. The inner electrode layer 3 may be formed using a commercially available electrode paste. The thickness of the inner electrode layer 3 may be appropriately determined depending on the intended application.

A conductive material contained in the outer electrodes 4 is not particularly limited. For example, a known conductive material such as Ni, Cu, Sn, Ag, Pd, Pt, Au, alloys thereof, or a conductive resin may be used. The thickness of each of the outer electrodes 4 may be appropriately determined depending on the intended applications.

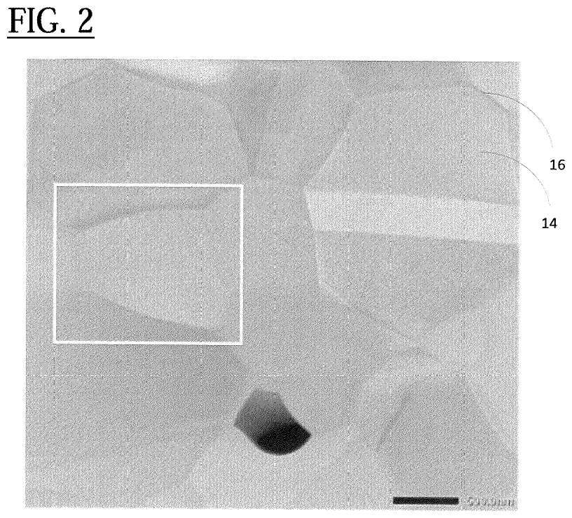

The method for observing the structure of the dielectric ceramic composition is not particularly limited. For example, a backscattered electron image or a HAADF image of a cross-section of the dielectric ceramic composition may be observed. The backscattered electron image can be obtained, for example, using a scanning electron image (SEM). The HAADF image can be observed, for example, using a scanning transmission electron microscope (STEM). The HAADF image of the cross-section of the dielectric ceramic composition is illustrated in FIG. 2. FIG. 2 is a HAADF image of Sample No. 1 to be described later. In the following description, the HAADF image observed using STEM is simply referred to as a STEM image.

As illustrated in FIG. 2, the dielectric ceramic composition according to the present embodiment includes main phase grains 14 and a grain boundary 16 existing between the main phase grains 14. In the backscattered electron image and the HAADF image, the main phase grains 14 can be recognized as portions having brighter contrast than the grain boundary 16 in many cases. The reason for this is that the density of the main phase grains 14 is higher than that of the grain boundary 16 in many cases. Accordingly, the grain boundary 16, the density of which is lower than that of the main phase grains 14, may be recognized as portions having darker contrast in many cases.

The width of a field of view to be photographed and the number of images are not particularly limited, but for example, each field of view has dimensions of approximately 1 to 10 μm square, and an area of 1 to 100 μm². The width of the field of view to be photographed and the number of images may be appropriately selected depending on the purpose.

Each of the main phase grains 14 contains a perovskite-type compound as a main component. The perovskite-type compound is a compound having a perovskite type crystal structure expressed by the general formula ABO₃ (A is an A-site element and B is the B-site element).

The perovskite-type compound contains at least Ca as the A-site element and at least Zr as the B-site element. The perovskite-type compound may further contain Sr and/or Ba as the A-site element, and may further contain Ti and/or Hf as the B-site element.

In a case where Ca is not contained as the A-site element, temperature characteristics and reliability deteriorate.

In a case where Zr is not contained as the B-site element, the temperature characteristics and the reliability deteriorate.

The content of Ca with respect to 100 parts by mole of the A-site element, that is, the total content of 100 parts by mole of Ca, Sr, and Ba may be 30 parts by mole or more and 100 parts by mole or less, 30 parts by mole or more and 90 parts by mole or less, or 50 parts by mole or more and 80 parts by mole or less. The content of Sr with respect to 100 parts by mole of the A-site element may be 0 parts by mole or more 50 parts by mole or less, 10 parts by mole or more and 50 parts by mole or less, or 20 parts by mole or more and 45 parts by mole or less. The content of Ba with respect to 100 parts by mole of the A-site element may be 0 parts by mole or more and 20 parts by mole or less, or 0 parts by mole or more and 5.0 parts by mole or less.

The content of Zr with respect to 100 parts by mole of the B-site element, that is, the total content of 100 parts by mole of Zr, Ti, and Hf may be 90 parts by mole or more and 100 parts by mole or less, 90 parts by mole or more and 99 parts by mole or less, or 94 parts by mole or more and 98 parts by mole or less. The content of Ti with respect to 100 parts by mole of the B-site element may be 0 parts by mole or more and less than 7.0 parts by mole, 0.5 parts by mole or more and less than 7.0 parts by mole, or 2.0 parts by mole or more and 6.0 parts by mole or less. The content of Hf with respect to 100 parts by mole of the B-site element may be 0 parts by mole or more and 10.0 parts by mole or less, or 0 parts by mole or more and 5.0 parts by mole or less.

The dielectric ceramic composition according to the present embodiment contains at least one selected from the group consisting of V, Nb, Ta, and W at least as a first additive element Z1 in addition to the perovskite-type compound. In a case where Z1 is not contained, the main phase grains 14 cannot include the first microscopic region to be described later.

In the dielectric ceramic composition according to the present embodiment, the total content of Z1 with respect to the total content of the B-site element, that is, the total content of Zr, Ti, and Hf is 0.005 parts by mole or more and 0.80 parts by mole or less. The total content may be 0.02 parts by mole or more and 0.80 parts by mole or less.

The dielectric ceramic composition according to the present embodiment may further contain at least one selected from the group consisting of Mn, Cr, Si, and Al as the second additive element Z2 in addition to the perovskite-type compound and Z1. The dielectric ceramic composition according to the present embodiment may contain at least one selected from the group consisting of Mn and Cr, Si, and Al as the second additive element Z2.

In the dielectric ceramic composition according to the present embodiment, the total content of Z2 with respect to the total content of the B-site element, that is, the total content of Zr, Ti, and Hf may be 1.8 parts by mole or more and 7.0 parts by mole or less.

In the dielectric ceramic composition according to the present embodiment, the total content of Mn and Cr may be more than the content of Si, and the content of Si in the grain boundary 16 may be more than the total content of Mn and Cr. Specifically, in the dielectric ceramic composition, a value obtained by subtracting the content of Si with respect to 100 parts by mole of the B-site element from the total content of Mn and Cr with respect to 100 parts by mole of the B-site element may be 0.1 parts by mole or more. Furthermore, a value obtained by subtracting the total content of Mn and Cr with respect to 100 parts by mole of the B-site element from the content of Si with respect to 100 parts by mole of the B-site element in the grain boundary 16 may be 0.1 parts by mole or more.

The total content of Ti, Mn, Cr, and Z1 with respect to 100 parts by mole of the B-site element may be 8.0 parts by mole or less.

Furthermore, the dielectric ceramic composition may contain at least one selected from the group consisting of Mg, Li, B, and P as the third additive element Z3. The total content of Z3 with respect to 100 parts by mole of the B-site element may be 0 parts by mole or more and 8 parts by mole or less.

An average grain size of the main phase grains 14 is not particularly limited. For example, the average grain size may be 0.1 μm or more and 5.0 μm or less, or 0.5 μm or more and 3.0 μm or less.

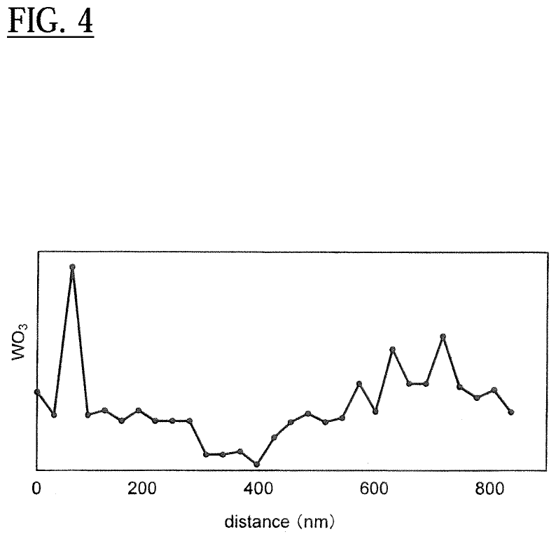

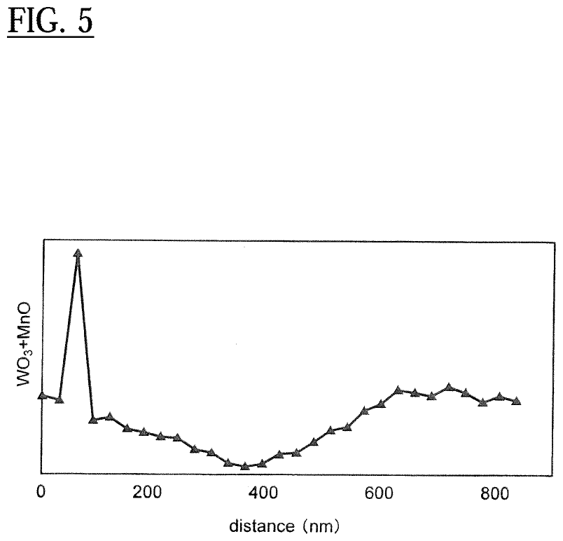

In the dielectric ceramic composition, 99% by weight or more of the A-site element, the B-site element, Z1, Z2, and Z3 is contained as simple oxides or composite oxides. FIG. 4 and FIG. 5 to be described later illustrate a change of the content of a simple oxide of each element, but actually, illustrate a change of the content of each element in terms of a simple oxide. Each element is contained in the dielectric ceramic composition as a type of a simple oxide, a composite oxide, or the like.

At least a part of the main phase grains 14 contained in the dielectric ceramic composition according to the present embodiment is composed of specific main phase grains. Each of the specific main phase grains includes a first microscopic region and a second microscopic region, the first microscopic region is included in an outer peripheral portion, the second microscopic region is included in a central portion, and the content of Z1 with respect to 100 parts by mole of the B-site element in the second microscopic region is lower than that in the first microscopic region.

A content of Z1 contained in the first microscopic region may be 0.08 parts by mole or more in terms of oxide, with respect to 100 parts by mole in terms of oxide of the total content of all elements contained in the first microscopic region. A content of Z1 contained in the second microscopic region may be less than 0.08 parts by mole in terms of oxide, with respect to 100 parts by mole in terms of oxide of the total content of all elements contained in the second microscopic region.

The total content of Mn, Cr, and Z1 contained in the first microscopic region may be 0.5 parts by mole or more in terms of oxide, with respect to 100 parts by mole in terms of oxide of the total content of all elements contained in the first microscopic region. The total content of Mn, Cr, and Z1 contained in the second microscopic region may be less than 0.5 parts by mole in terms of oxide, with respect to 100 parts by mole in terms of oxide of the total content of all elements contained in the second microscopic region.

In an any cross-section of the dielectric ceramic composition, an outer peripheral portion of the main phase grains 14 is a portion existing within one-fourth of an equivalent circle radius from the grain boundary 16 toward the main phase grains 14. The first microscopic region may extend from the grain boundary toward the center of the specific main phase grain by a distance of at least one-fourth of an equivalent circle radius.

The center of the main phase grain 14 indicates the center of the main phase grain 14 on any cross-section. The central portion of the main phase grain 14 is a portion in which a distance from the center of the main phase grain 14 is at most approximately the half the equivalent circle radius.

The equivalent circle radius is a radius of circles having the same area. In addition, the equivalent circle radius is a length that is approximately the half of an equivalent circle diameter.

The ratio of the number of the specific main phase grains to the number of the main phase grains 14, each being contained in the dielectric ceramic composition, may be 5% or more and 95% or less, or 10% or more and 95% or less. When calculating the ratio of the numbers, first, two or more fields of view are observed in an observation range having an area of 6.0 μm² or more in any cross-section of the dielectric ceramic composition. Then, the number of the main phase grains 14 of which the entirety is included in the observation range is calculated. Furthermore, the number of the specific main phase grains among the main phase grains 14 of which the entirety is included in the observation range is calculated. Then, the ratio of the numbers is calculated.

An area ratio of the first microscopic region in any cross-section of the dielectric ceramic composition may be 5% or more and 95% or less, or 20% or more and 95% or less. When calculating the area ratio of the first microscopic region, first, in any cross-section of the dielectric ceramic composition, two or more fields of view are observed in an observation range having an area of 6.0 μm² or more. Then, an area of the first microscopic region in the main phase grain 14 within the observation range is divided by the area of the observation range.

Description will be given of a change of the content of each element in the main phase grains 14 and the grain boundary 16 with reference to specific examples.

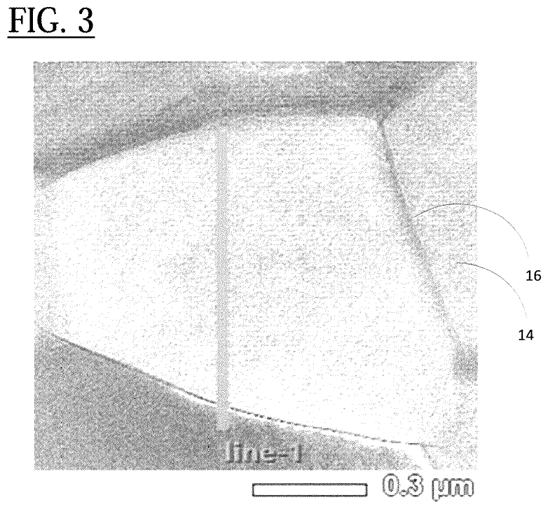

FIG. 3 is a STEM image obtained by enlarging a portion indicated by the square in FIG. 2. Graphs showing results of line analysis using a STEM-EDS from a lower end to an upper end along a line indicated by line-1 in FIG. 3 are illustrated in FIGS. 4 and 5. The dielectric ceramic composition for which various measurement results are illustrated in FIGS. 2 to 5 contain W as Z1, but the same tendency is observed even when another Z1 is used instead of W. In addition, the dielectric ceramic composition for which various measurement results are illustrated in FIGS. 2 to 5 contain Mn but does not contain Cr as Z2, the same tendency is observed even when Cr is used instead of Mn of the dielectric ceramic composition.

According to FIGS. 4 and 5, in the main phase grains 14, a content of W (the content of Z1) and the total content of W and Mn tend to increase as approaching the grain boundary 16. Then, in the grain boundary 16, the content of W, and the total content of W and Mn become significantly larger.

The dielectric ceramic composition may include a segregation in addition to the main phase grains 14 and the grain boundary 16. The segregation may include Mn.

Hereinafter, an example of the method for manufacturing the multilayer ceramic capacitor 1 illustrated in FIG. 1 will be described.

First, a process of manufacturing the element body 10 will be described. In the process of manufacturing the element body 10, a dielectric paste that becomes the dielectric layer 2 after firing, and an inner electrode paste that becomes the inner electrode layer 3 after firing are prepared.

The method for producing the dielectric paste is not particularly limited. For example, the dielectric paste is produced by production methods shown in the following Production Method 1 to Production Method 4.

### (Production Method 1)

A raw material powder (hereinafter, may be described as “main component raw material powder”) of the main phase grains 14 of mainly the dielectric ceramic composition is prepared. A commercially available perovskite-type compound powder may be prepared as the raw material powder. In addition, the main component raw material powder may be prepared by preparing an oxide powder of the A-site element and an oxide powder of the B-site element of the perovskite-type compound, dispersing the powders in a solvent (for example, purified water), drying the resultant solution, and performing a heat treatment. The holding temperature in the heat treatment for preparing the main component raw material powder is not particularly limited. For example, the holding temperature may be 900° C. or higher and 1300° C. or lower, or 1000° C. or higher and 1250° C. or lower. The holding time is not particularly limited. For example, the holding time may be 0.5 hours or longer and 5.0 hours or shorter, or 1.0 hour or longer and 4.0 hours or shorter.

In addition, oxide powders of additive elements may be simultaneously dispersed in the solvent in combination with the oxide powder of the A-site element and the oxide powder of the B-site element of the perovskite-type compound.

A powder of a compound that becomes an oxide of each element by sintering, for example, a powder of a carbonate of each element, a powder of a chloride of each element, or a powder of a hydroxide of each element may be used instead of the oxide powder of each element. In addition, a powder of a composite compound of each element may be used.

A specific surface area of the main component raw material powder at this point of time is not particularly limited, but the specific surface area measured by a BET method may be 3.0 m²/g or more and 20.0 m²/g or less, 3.5 m²/g or more and 15.0 m²/g or less, or 5.0 m²/g or more and 12.0 m²/g or less. Particularly, when the specific surface area of the main component raw material powder is 5.0 m²/g or more and 12.0 m²/g or less, the specific main phase grains are likely to be generated.

Next, a powder of a main component raw material powder, an oxide powder of Mn (a powder of a compound that becomes an oxide of Mn by sintering may be used) and/or an oxide powder of Cr (a powder of a compound that becomes an oxide of Cr by sintering may be used), and an oxide powder of Z1 (a powder of a compound that becomes an oxide of Z1 by sintering may be used) are mixed to obtain a mixture, and then the mixture is calcined in a reducing atmosphere with an oxygen partial pressure of 1× 10⁻¹⁴ atm to 1×10⁻¹¹ atm. In the calcination, the holding temperature may be set to 800° C. or higher and 1300° C. or lower, and the holding time may be set to 0.5 hours or longer and 5.0 hours or shorter.

Due to the calcination in the above-described reducing atmosphere, the main component raw material powder is reduced, and an oxygen defect is likely to be generated. When an oxygen defect is generated, the crystal lattice becomes unstable, and a part of the A-site element or a part of the B-site element is likely to be substituted by Z1.

After adding an oxide powder of Z2 other than Mn and Cr (a powder of a compound that becomes an oxide of Z2 other than Mn and Cr by sintering may be used), and an oxide powder of Z3 (a powder of a compound that becomes an oxide of Z3 by sintering may be used) as necessary to the mixture after the calcination in the reducing atmosphere, and calcination is performed again. An atmosphere during the calcination is not particularly limited. For example, the calcination may be performed in the air. The holding temperature during the calcination may be set to 800° C. or higher and 1300° C. or lower, and the holding time during the calcination may be set to 0.5 hours or longer and 5.0 hours or shorter.

A dielectric powder is prepared by dispersing the mixture after the above-described calcination in a solvent (for example, purified water), drying the resultant solution, and performing a heat treatment. The holding temperature during the heat treatment is not particularly limited. For example, the holding temperature may be 300° C. or higher and 700° C. or lower, or 400° C. or higher and 650° C. or lower. The holding time is not particularly limited. For example, the holding time may be 2.0 hours or longer and 4.5 hours or shorter. When the dielectric powder is prepared by the above-described processes, the specific main phase grains are likely to be generated.

Then, the obtained dielectric powder, a binder, and a solvent (an organic solvent or water) are kneaded to produce a dielectric paste. The kinds of the binder and the solvent are not particularly limited. An organic vehicle that is obtained by mixing the binder and the organic solvent may be used instead of the binder and the solvent. The dielectric paste may contain an additive such as a plasticizer and a dispersant as necessary.

The inner electrode paste is obtained by kneading a raw material of the conductive material, a binder, and a solvent (an organic solvent or water). The kinds of the binder and the solvent are not particularly limited. The inner electrode paste may contain additives such as sintering inhibitors and plasticizers as necessary.

A green sheet and an inner electrode pattern are formed by the obtained respective pastes, and are laminated to obtain a green chip.

A binder removal treatment may be performed on the obtained green chip as necessary. Binder removal treatment conditions may be known condition. For example, the holding temperature may be set to 180° C. or higher and 400° C. or lower, and the holding time may be set to 0.5 hours or longer and 24 hours or shorter. In addition, an atmosphere during the binder removal treatment is also not particularly limited. In addition, the holding temperature under a reducing atmosphere may be set to 1100° C. or lower.

After the binder removal treatment, the green chip is fired to obtain the element body 10. In the present embodiment, an atmosphere during firing may be set to a reducing atmosphere with an oxygen partial pressure of 2.0×10⁻¹³ atm or more and 1.0×10⁻⁷ atm or less. The other firing conditions may be set to known conditions. For example, the holding temperature may be set to 1200° C. or higher and 1400° C. or lower, and the holding time may be set to 0.5 hours or longer and 8.0 hours or shorter.

After the firing, an annealing treatment may be performed as necessary. Annealing treatment conditions are not particularly limited. For example, the holding temperature may be set to 500° C. or higher and 1150° C. or lower, and the holding time may be set to 0.5 hours or longer and 20 hours or shorter. An oxygen partial pressure in an annealing atmosphere may be set to, for example, 1.0×10⁻⁹ atm or more and 3.0×10⁻⁵ atm or less.

### (Production Method 2)

In Production Method 2, a process up to the preparation of the main component raw material powder and the process after preparing the dielectric powder are the same as those in Production Method 1.

In Production Method 2, a part of the oxide powders of the additive elements is added as sintering aids obtained from Al₂O₃, MnCO₃, and SiO₂. The sintering aids are prepared by mixing powders consisting of the three kinds of compounds and calcining the resultant mixture. The amount of the sintering aids added is not particularly limited, but 1 part by weight or more and 5 parts by weight or less of sintering aids may be added with respect to 100 parts by weight of main component raw material powder.

In the sintering aids, the content of MnCO₃ may be 55% by weight or more and 75% by weight or less, the content of Al₂O₃ may be 2% by weight or more and 15% by weight or less, and the content of SiO₂ may be 15% by weight or more and 40% by weight or less. With regard to calcination conditions, for example, a firing temperature may be 800° C. or higher and 1200° C. or lower, and the holding time may be 1.0 hour or longer and 5.0 hours or shorter. When the holding temperature is 900° C. or higher and 1100° C. or lower, and the holding time is 2.0 hours or longer and 4.0 hours or shorter, the specific main phase grains are likely to be generated.

Next, after obtaining a mixture by mixing the main component raw material powder and the sintering aids, a dielectric powder is prepared by dispersing the resultant mixture and an oxide powder of an additive element (a powder of a compound that becomes an oxide of each element by sintering may be used) in a solvent (for example, purified water), by drying the resultant solution, and by performing a heat treatment. The holding temperature during the heat treatment is not particularly limited. For example, the holding temperature may be 300° C. or higher and 700° C. or lower, or 400° C. or higher and 650° C. or lower. The holding time is not particularly limited. For example, the holding time may be 0.5 hours or longer and 5.0 hours or shorter, or 2.0 hours or longer and 4.5 hours or shorter. When the holding temperature is 450° C. or higher and 600° C. or lower, and the holding time is 2.5 hours or longer and 4.0 hours or shorter, the specific main phase grains are likely to be generated.

### (Production Method 3)

Production Method 3 is the same as Production Method 2 except for the following points.

After at least a part of the oxide powder of the additive element is calcined to obtain a calcined product, the above-described mixture, the calcined product, and the oxide powder of the additive element that is not calcined are dispersed together in a solvent. As calcination conditions in this case, for example, a firing temperature may be 800° C. or higher and 1200° C. or lower, and the holding time may be 1.0 hour or longer and 5.0 hours or shorter.

### (Production Method 4)

Production Method 4 is the same as Production Method 2 except for the following points.

After mixing the main component raw material powder and the oxide powders of the additive elements other than the sintering aids and calcining the resultant mixture to obtain a calcined product, the calcined product and the sintering aids are dispersed together in a solvent. With regard to calcination conditions in this case, for example, a temperature may be 800° C. or higher and 1200° C. or lower, and the holding time may be 1.0 hour or longer and 5.0 hours or shorter.

The dielectric ceramic composition constituting the dielectric layer 2 of the element body 10, which is obtained as described above, is the above-described dielectric ceramic composition. An end surface of the element body 10 is polished as necessary, and an outer electrode paste is applied and baked to form the outer electrodes 4. Then, a coating layer is formed on a surface of the outer electrodes 4 by plating or the like as necessary. The method for preparing the outer electrode paste is not particularly limited, and the outer electrode paste may be prepared by a similar method as in the inner electrode paste.

As described above, the multilayer ceramic capacitor 1 according to the present embodiment is manufactured.

Hereinbefore, the embodiment of the present disclosure has been described, but the present disclosure is not limited to the above-described embodiment, and various modifications can be made within a range not departing from the gist of the present disclosure.

### EXAMPLES

Hereinafter, the present disclosure will be described with reference to more detailed examples, but the present disclosure is not limited to the examples.

### Experimental Example 1

In Experimental Example 1, the multilayer ceramic capacitor 1 illustrated in FIG. 1 was manufactured in the following procedure.

First, the dielectric paste was prepared.

A raw material powder (hereinafter, may be described as a main component raw material powder) of the perovskite-type compound contained as a main component of the main phase grains was prepared. Specifically, a raw material powder of a Ca oxide, a raw material powder of a Sr oxide, a raw material powder of a Ba oxide, a raw material powder of a Zr oxide, and a raw material powder of a Ti oxide were prepared and weighed to obtain perovskite-type compounds shown in Table 1. The term “a raw material powder of a y oxide” represents a powder of the y oxide and/or a powder of a compound that becomes the y oxide by heat treatment. Then, respective powders were dispersed in purified water, and the resultant dispersed solution was dried and subjected to a heat treatment (the holding temperature was 1150° C. to 1250° C., and the holding time was 0.5 to 5 hours) to prepare a main component raw material powder of which a specific surface area measured by a BET method is 7.0 m²/g.

Additionally, a raw material powder of an oxide of Z1 (a raw material powder of a W oxide), and a raw material powder of oxides of Z2 (a MnCO₃ powder, a Cr₂O₃ powder, a SiO₂ powder, and/or Al₂O₃ powder) were prepared and weighed. In this case, the order of Z1 and Z2 shown in Table 1 was set to a descending order of a content based on the number of atoms. Then, the total content of Z1 and the total content of Z2 with respect to 100 parts by mole of the total content of Zr and Ti were set to values shown in Table 1.

Next, the main component raw material powder, the MnCO₃ powder and/or the Cr₂O₃ powder, and the raw material powder of the W oxide were mixed to obtain a mixture, and the mixture was calcined in a reducing atmosphere with an oxygen partial pressure of 1×10⁻¹² atm. The holding temperature during the calcination was set to 1200° C. and the holding time during the calcination was set to 4 hours.

The Al₂O₃ powder and the SiO₂ powder were added to the mixture after the calcination in the reducing atmosphere, and the resultant mixture was calcined again in the air. The holding temperature during the calcination was set to 1200° C. and the holding time during the calcination was set to 2 hours.

The mixture after the calcination was dispersed in a solvent (for example, purified water), and the dispersed solution was dried and subjected to a heat treatment to obtain a dielectric powder. The holding temperature during heat treatment was 550° C. and the holding time during the heat treatment was set to 3.5 hours.

The dielectric powder and an organic vehicle were kneaded to prepare a dielectric paste. 100 parts by mass of the dielectric powder, 10 parts by mass of polyvinyl butyral resin, 5 parts by mass of dioctyl phthalate (DOP) as a plasticizer, and 100 parts by mass of alcohol as a solvent were mixed with a ball mill to be a paste, thereby obtaining the dielectric paste.

The method for preparing the inner electrode paste is as follows. First, a Ni powder, terpineol, ethyl cellulose, and benzotriazole were prepared in a mass ratio of 44.6:52.0:3.0:0.4. Then, these were kneaded by three rolls to be paste, thereby preparing the inner electrode paste.

Next, a green chip was manufactured by a sheet forming method using the above-described dielectric paste and the inner electrode paste. Then, the green chip was subjected to a binder removal treatment, a firing treatment, and an annealing treatment to obtain a rectangular parallelepiped element body 10 having dimensions of 3.2 mm×1.6 mm×0.7 mm. With regard to the dimensions, a dimension in a horizontal direction in FIG. 1 is 3.2 mm, and a dimension in a vertical direction (laminating direction) in FIG. 1 is 0.7 mm. In the firing treatment, the holding temperature during the firing treatment was set to 1200° C. to 1300° C., the holding time was set to 2.0 hours, an atmosphere during the firing was set to a reducing atmosphere with an oxygen partial pressure of 2.0× 10⁻¹³ atm or more and 1.0×10⁻⁷ atm or less. In addition, in the obtained element body 10, the number of the laminated dielectric layers 2 each being sandwiched between the inner electrode layers 3 was set to 10, an average thickness of the dielectric layers 2 each being sandwiched between the inner electrode layer 3 was set to 5.0 μm, and an average thickness of the inner electrode layers 3 was set to 1.2 μm.

With regard to the holding temperature during the firing, a preliminary test was performed on respective samples at six holding temperatures: 1200° C., 1220° C., 1240° C., 1260° C., 1280° C., and 1300° C. Then, the lowest holding temperature among the holding temperatures at which the element body 10 was densified was adopted. Whether the element body 10 was densified was determined by observing a cross-section of the element body 10 using SEM. Specifically, it was determined whether the area of voids in a field of view of 450 μm² or more in a cross-section of the element body 10 was 2% or less of the area of the dielectric layers 2 in the field of view. In a case where the element body 10 was not densified at any of the holding temperatures, the holding temperature at which the degree of densification of the element body 10 was the highest was adopted. That is, the holding temperature was set to 1300° C.

Next, a baked electrode layer containing Cu, a Ni plated layer, and a Sn plated layer are sequentially formed in this order on an outer surface of the above-described element body 10 to form the outer electrode 4, thereby obtaining the multilayer ceramic capacitor 1.

### (Composition of Dielectric Ceramic Composition)

With regard to the composition of the dielectric ceramic composition, composition analysis was performed on the dielectric layers 2 using ICP emission spectroscopy. The content of the A-site element, the content of the B-site element, the content of each element contained in Z1, and the content of each element contained in Z2 were substantially the same between the batch composition and the composition of the dielectric ceramic composition. In all examples, the total content of Ti, Mn, Cr, and Z1 with respect to 100 parts by mole of the B-site element was 8.0 parts by mole or less.

### (Presence or Absence of Specific Main Phase Grains and Number Ratio Thereof)

The presence or absence of the specific main phase grains and the number ratio of the specific main phase grains to the total number of main phase grains were determined using STEM-EDS. Specifically, a plurality of observation ranges were set such that a total size was 20 μm² or more and observation was performed, and it was determined whether at least ten or more main phase grains 14 of which the entirety was included in each observation range were specific main phase grains. The results are shown in Table 1. In addition, for all specific main phase grains of all examples, a content of Z1 contained in the first microscopic region was 0.08 parts by mole or more in terms of oxide, with respect to 100 parts by mole in terms of oxide of the total content of all elements contained in the first microscopic region, and a content of Z1 contained in the second microscopic region was less than 0.08 parts by mole in terms of oxide, with respect to 100 parts by mole in terms of oxide of the total content of elements contained in the second microscopic region.

Furthermore, in all examples, the total content of Mn, Cr, and Z1 contained in the first microscopic region was 0.5 parts by mole or more in terms of oxide, with respect to 100 parts by mole in terms of oxide of the total content of all elements contained in the first microscopic region, and the total content of Mn, Cr, and Z1 contained in the second microscopic region was less than 0.5 parts by mole in terms of oxide, with respect to 100 parts by mole in terms of oxide of the total content of all elements contained in the second microscopic region.

### (Z2 Contained in Grain Boundary 16)

The content of each element contained in the grain boundary 16 was determined using STEM-EDS. It all examples, the content of Si in the grain boundary 16 was higher than the total content of Mn and Cr.

### (Average Grain Size of Main Phase Grains 14)

An average grain size of the main phase grains 14 was measured by observing a cross-section of the dielectric layers 2 using SEM. Specifically, an observation range including 50 or more main phase grains 14 of which the entirety is included was set, and an equivalent circle diameter of each of the main phase grains 14 was calculated and averaged to measure an average grain size. The equivalent circle diameter of the main phase grain 14 is a diameter of a circle having the same area as the main phase grain 14. The results are shown in Table 1.

### (Area Ratio of First Microscopic Region)

An area ratio of the first microscopic region was measured by observing a cross-section of the dielectric layers 2 using STEM-EDS. Specifically, a plurality of observation ranges were set such that a total size was 20 μm² or more and observation was performed, and the area ratio of the first microscopic region in each of the observation regions was calculated. The results are shown in Table 1. In a case where the specific main phase grains were not included in the observation range, the area ratio of the first microscopic region was set to 0. In all specific main phase grains of all examples, the first microscopic region extended from the grain boundary toward the center of the specific main phase grain by a distance of at least one-fourth of the equivalent circle radius.

### (Temperature Characteristics)

Temperature characteristics of the multilayer ceramic capacitor 1 was evaluated by measuring a temperature coefficient of capacitance TC (unit: ppm/° C.). Specifically, a signal with a frequency of 1 kHz and an input signal level (measurement voltage) of 1 Vrms was input to the multilayer ceramic capacitor at 25° C. and 125° C., and the capacitance at each temperature range was measured. Then, TC was calculated from a capacitance C25 at 25° C. and a capacitance C125 at 125° C. by the following equation.

$$τ C = \{ ( C 125 - C 25 ) / C 25 \} \times \{ 1 / ( 125 - 25 ) \}$$

τC was measured for ten multilayer ceramic capacitors 1, and an average value of τC was calculated. In a case where the average value of τC was −30 ppm/° C. or more and +30 ppm/° C. or less, possible was described in a temperature characteristic column in Table 2. In a case where the average value of τC was less than −30 ppm/° C. or more than +30 ppm/° C., impossible was described in the temperature characteristic column in Table 2.

### (Reliability Test)

High-temperature load life of the multilayer ceramic capacitor 1 was evaluated. Specifically, the multilayer ceramic capacitor 1 was held at 200° C. in a state of being applied with a DC voltage of 800 V (160 V/μm) to measure the service life. In the present examples, the service life was defined as the shortest time between time from the start of application until insulation resistance dropped by one digit and time from the start of application until a sample failed. In the present examples, the above-described evaluation was performed on twenty multilayer ceramic capacitors 1, and a mean time to failure (MTTF) was calculated of the service life of each of the multilayer ceramic capacitor 1. In a case where MTTF was 2.00×10² hours or longer and shorter than 1.00×10³ hours, reliability was evaluated as satisfactory, and in a case where MTTF was 1.00× 10³ hours or longer, the reliability was evaluated as particularly satisfactory. The results are shown in Table 1. In Table 1, the notation “rE+s” denotes r×10^{S}.

TABLE 1

| | | | | Entire Dielectric Layer | | | |
|---|---|---|---|---|---|---|---|
| | | | | Type of Z1 | Z1 | Type of Z2 | Z2 |
| Example/ | | | | (descending | Content | (descending | Content |
| Comparative | Sample | Perovskite-Type Compound | | order of | [parts by | order of | [parts by |
| Example | No. | A-site | B-site | content) | mole] | content) | mole] |
| Example | 1 | Ca_{0.70}Sr_{0.30} | Zr_{0.96}Ti_{0.03}Hf_{0.01} | W | 0.25 | Mn, Si, Al | 4.0 |
| Example | 2 | Ca_{0.10}Sr_{0.65}Ba_{0.25} | Zr_{0.96}Ti_{0.03}Hf_{0.01} | W | 0.26 | Mn, Si, Al | 4.1 |
| Example | 3 | Ca | Zr | W | 0.25 | Mn, Si, Al | 4.1 |
| Comparative | 4 | Ba | Ti | W | 0.24 | Mn, Si, Al | 4.0 |
| Example | | | | | | | |
| Comparative | 5 | Sr | Zr_{0.96}Ti_{0.03}Hf_{0.01} | W | 0.26 | Mn, Si, Al | 4.0 |
| Example | | | | | | | |
| Comparative | 6 | Ca_{0.70}Sr_{0.30} | Ti | W | 0.25 | Mn, Si, Al | 4.1 |
| Example | | | | | | | |

| | | Specific Main Phase Grains | | | Main | | |
|---|---|---|---|---|---|---|---|
| | | | | Area Ratio of | Phase | | |
| | | | | First | Grains | | |
| Example/ | | | Number | Microscopic | Grain | Characteristics | |
| Comparative | Sample | Present/ | Ratio | Region | Size | Temperature | MTTF |
| Example | No. | Absent | [%] | [%] | [um] | Characteristics | [h] |
| Example | 1 | Present | 25 | 42 | 1.5 | Satisfactory | 1.37.E+03 |
| Example | 2 | Present | 32 | 54 | 1.0 | Satisfactory | 1.34.E+03 |
| Example | 3 | Present | 30 | 50 | 1.2 | Satisfactory | 1.35.E+03 |
| Comparative | 4 | Present | 21 | 35 | 1.5 | Unsatisfactory | 2.50.E+01 |
| Example | | | | | | | |
| Comparative | 5 | Present | 34 | 39 | 1.5 | Unsatisfactory | 1.27.E+02 |
| Example | | | | | | | |
| Comparative | 6 | Present | 30 | 48 | 1.4 | Unsatisfactory | 1.35.E+02 |
| Example | | | | | | | |

As shown in Table 1, Sample Nos. 1 to 3, in which a perovskite-type compound having a predetermined composition was contained as a main component and at least a part of the main phase grains 14 was composed of the specific main phase grains, exhibited satisfactory temperature characteristics and reliability.

In contrast, Sample Nos. 4 and 5, in which Ca was not contained as the A-site element, and Sample No. 6, in which Zr was not contained as the B-site element, exhibited insufficient temperature characteristics and reliability.

### Experimental Example 2

With respect to Sample No. 1, the content of mainly Z1 (W) was changed to prepare Sample Nos. 11 to 16, the same experiment as in Experimental Example 1 was performed. The results are shown in Table 2.

TABLE 2

| | | | | Entire Dielectric Layer | | | |
|---|---|---|---|---|---|---|---|
| | | | | Type of Z1 | Z1 | Type of Z2 | Z2 |
| Example/ | | | | (descending | Content | (descending | Content |
| Comparative | Sample | Perovskite-Type Compound | | order of | [parts by | order of | [parts by |
| Example | No. | A-site | B-site | content) | mole] | content) | mole] |
| Comparative | 11 | Ca_{0.70}Sr_{0.30} | Zr_{0.96}Ti_{0.03}Hf_{0.01} | Without Z1 | | Mn, Si, Al | 3.9 |
| Example | | | | | | | |
| Comparative | 12 | Ca_{0.70}Sr_{0.30} | Zr_{0.96}Ti_{0.03}Hf_{0.01} | W | 0.001 | Mn, Si, Al | 4.0 |
| Example | | | | | | | |
| Example | 13 | Ca_{0.70}Sr_{0.30} | Zr_{0.96}Ti_{0.03}Hf_{0.01} | W | 0.005 | Mn, Si, Al | 4.0 |
| Example | 14 | Ca_{0.70}Sr_{0.30} | Zr_{0.96}Ti_{0.03}Hf_{0.01} | W | 0.02 | Mn, Si, Al | 3.9 |
| Example | 1 | Ca_{0.70}Sr_{0.30} | Zr_{0.96}Ti_{0.03}Hf_{0.01} | W | 0.25 | Mn, Si, Al | 4.0 |
| Example | 15 | Ca_{0.70}Sr_{0.30} | Zr_{0.96}Ti_{0.03}Hf_{0.01} | W | 0.78 | Mn, Si, Al | 3.9 |
| Comparative | 16 | Ca_{0.70}Sr_{0.30} | Zr_{0.96}Ti_{0.03}Hf_{0.01} | W | 1.5 | Mn, Si, Al | 4.0 |
| Example | | | | | | | |

| | | Specific Main Phase Grains | | | Main | | |
|---|---|---|---|---|---|---|---|
| | | | | Area Ratio of | Phase | | |
| | | | | First | Grains | | |
| Example/ | | | Number | Microscopic | Grain | Characteristics | |
| Comparative | Sample | Present/ | Ratio | Region | Size | Temperature | MTTF |
| Example | No. | Absent | [%] | [%] | [um] | Characteristics | [h] |
| Comparative | 11 | Absent | 0 | 0 | 1.4 | Satisfactory | 1.22.E+02 |
| Example | | | | | | | |
| Comparative | 12 | Present | 3 | 6 | 1.3 | Satisfactory | 1.35.E+02 |
| Example | | | | | | | |
| Example | 13 | Present | 5 | 8 | 1.9 | Satisfactory | 2.19.E+02 |
| Example | 14 | Present | 12 | 20 | 1.1 | Satisfactory | 1.37.E+03 |
| Example | 1 | Present | 25 | 42 | 1.5 | Satisfactory | 1.37.E+03 |
| Example | 15 | Present | 92 | 51 | 1.3 | Satisfactory | 1.30.E+03 |
| Comparative | 16 | Absent | 0 | 0 | 1.3 | Satisfactory | 1.06.E+02 |
| Example | | | | | | | |

As shown in Table 2, Sample Nos. 13 to 15, in which the content of Z1 was 0.005 parts by mole or more and 0.80 parts by mole or less, exhibited satisfactory temperature characteristics and insulation resistance. In contrast, Sample No 11, in which Z1 was not contained, Sample No. 12, in which the content of Z1 was extremely small, and Sample No. 16, in which the content of Z1 was excessively large, exhibited insufficient reliability.

### Experimental Example 3

The type of Z1 was mainly changed from Sample No. 1 to obtain Sample No. 21 to 28, and the same experiment as in Experiment Example 1 was performed. In Sample No. 21, the ratio of W and Nb was 1:1 based on the number of atoms, and in Sample No. 22, the ratio of W and Ta was 1:1 based on the number of atoms. In Sample No. 26, Mo was contained instead of Z1. In Sample No. 27, Dy was contained instead of Z1. In Sample No. 28, Y was contained instead of Z1. Sample No. 11 in Experimental Example 2 is a sample in which components other than the main component and an oxide of Z2 were not substantially contained. The results are shown in Table 3.

TABLE 3

| | | | | Entire Dielectric Layer | | | |
|---|---|---|---|---|---|---|---|
| | | | | Type of Z1 | Z1 | Type of Z2 | Z2 |
| Example/ | | | | (descending | Content | (descending | Content |
| Comparative | Sample | Perovskite-Type Compound | | order of | [parts by | order of | [parts by |
| Example | No. | A-site | B-site | content) | mole] | content) | mole] |
| Example | 1 | Ca_{0.70}Sr_{0.30} | Zr_{0.96}Ti_{0.03}Hf_{0.01} | W | 0.25 | Mn, Si, Al | 4.0 |
| Example | 21 | Ca_{0.70}Sr_{0.30} | Zr_{0.96}Ti_{0.03}Hf_{0.01} | W, Nb | 0.25 | Mn, Si, Al | 4.1 |
| Example | 22 | Ca_{0.70}Sr_{0.30} | Zr_{0.96}Ti_{0.03}Hf_{0.01} | W, Ta | 0.26 | Mn, Si, Al | 4.1 |
| Example | 23 | Ca_{0.70}Sr_{0.30} | Zr_{0.96}Ti_{0.03}Hf_{0.01} | Nb | 0.27 | Mn, Si, Al | 4.2 |
| Example | 24 | Ca_{0.70}Sr_{0.30} | Zr_{0.96}Ti_{0.03}Hf_{0.01} | Ta | 0.23 | Mn, Si, Al | 4.0 |
| Example | 25 | Ca_{0.70}Sr_{0.30} | Zr_{0.96}Ti_{0.03}Hf_{0.01} | V | 0.27 | Mn, Si, Al | 4.0 |
| Comparative | 26 | Ca_{0.70}Sr_{0.30} | Zr_{0.96}Ti_{0.03}Hf_{0.01} | Without Z1 (Mo 0.26 | | Mn, Si, Al | 4.2 |
| Example | | | | parts by mole) | | | |
| Comparative | 27 | Ca_{0.70}Sr_{0.30} | Zr_{0.96}Ti_{0.03}Hf_{0.01} | Without Z1 (Dy 0.27 | | Mn, Si, Al | 4.0 |
| Example | | | | parts by mole) | | | |
| Comparative | 28 | Ca_{0.70}Sr_{0.30} | Zr_{0.96}Ti_{0.03}Hf_{0.01} | Without Z1 (Y 0.27 | | Mn, Si, Al | 4.1 |
| Example | | | | parts by mole) | | | |
| Comparative | 11 | Ca_{0.70}Sr_{0.30} | Zr_{0.96}Ti_{0.03}Hf_{0.01} | Without Z1 | | Mn, Si, Al | 3.9 |
| Example | | | | | | | |

| | | Specific Main Phase Grains | | | Main | | |
|---|---|---|---|---|---|---|---|
| | | | | Area Ratio of | Phase | | |
| | | | | First | Grains | | |
| Example/ | | | Number | Microscopic | Grain | Characteristics | |
| Comparative | Sample | Present/ | Ratio | Region | Size | Temperature | MTTF |
| Example | No. | Absent | [%] | [%] | [um] | Characteristics | [h] |
| Example | 1 | Present | 25 | 42 | 1.5 | Satisfactory | 1.37.E+03 |
| Example | 21 | Present | 28 | 48 | 1.3 | Satisfactory | 1.37.E+03 |
| Example | 22 | Present | 28 | 46 | 1.6 | Satisfactory | 1.33.E+03 |
| Example | 23 | Present | 21 | 36 | 1.9 | Satisfactory | 1.31.E+03 |
| Example | 24 | Present | 27 | 45 | 1.2 | Satisfactory | 1.08.E+03 |
| Example | 25 | Present | 21 | 35 | 1.3 | Satisfactory | 1.21.E+03 |
| Comparative | 26 | Absent | 0 | 0 | 1.7 | Satisfactory | 1.60.E+02 |
| Example | | | | | | | |
| Comparative | 27 | Absent | 0 | 0 | 1.7 | Satisfactory | 1.60.E+02 |
| Example | | | | | | | |
| Comparative | 28 | Absent | 0 | 0 | 1.5 | Satisfactory | 3.20.E+01 |
| Example | | | | | | | |
| Comparative | 11 | Absent | 0 | 0 | 1.4 | Satisfactory | 1.22.E+02 |
| Example | | | | | | | |

As shown in Table 3, Sample Nos. 21 to 25 having a predetermined composition and a predetermined configuration exhibited satisfactory temperature characteristics and reliability. In contrast, Sample Nos. 26 to 28, in which W was not used and an element other than Z1 was used instead, and Sample No. 11, in which Z1 was not added to the composition of Sample No. 1, exhibited deteriorated reliability.

### Experimental Example 4

With respect to Sample No. 1, mainly the average grain size of the main phase grain was changed, and the same experiment as in Experimental Example 1 was performed. The results are shown in Table 4.

TABLE 4

| | | | | Entire Dielectric Layer | | | |
|---|---|---|---|---|---|---|---|
| | | | | Type of Z1 | Z1 | Type of Z2 | Z2 |
| Example/ | | | | (descending | Content | (descending | Content |
| Comparative | Sample | Perovskite-Type Compound | | order of | [parts by | order of | [parts by |
| Example | No. | A-site | B-site | content) | mole] | content) | mole] |
| Example | 31 | Ca_{0.70}Sr_{0.30} | Zr_{0.96}Ti_{0.03}Hf_{0.01} | W | 0.23 | Mn, Si, Al | 4.1 |
| Example | 32 | Ca_{0.70}Sr_{0.30} | Zr_{0.96}Ti_{0.03}Hf_{0.01} | W | 0.25 | Mn, Si, Al | 3.9 |
| Example | 1 | Ca_{0.70}Sr_{0.30} | Zr_{0.96}Ti_{0.03}Hf_{0.01} | W | 0.25 | Mn, Si, Al | 4.0 |
| Example | 33 | Ca_{0.70}Sr_{0.30} | Zr_{0.96}Ti_{0.03}Hf_{0.01} | W | 0.23 | Mn, Si, Al | 4.0 |
| Example | 34 | Ca_{0.70}Sr_{0.30} | Zr_{0.96}Ti_{0.03}Hf_{0.01} | W | 0.27 | Mn, Si, Al | 4.1 |

| | | Specific Main Phase Grains | | | Main | | |
|---|---|---|---|---|---|---|---|
| | | | | Area Ratio of | Phase | | |
| | | | | First | Grains | | |
| Example/ | | | Number | Microscopic | Grain | Characteristics | |
| Comparative | Sample | Present/ | Ratio | Region | Size | Temperature | MTTF |
| Example | No. | Absent | [%] | [%] | [um] | Characteristics | [h] |
| Example | 31 | Present | 24 | 40 | 0.1 | Satisfactory | 4.78.E+02 |
| Example | 32 | Present | 27 | 45 | 0.6 | Satisfactory | 1.32.E+03 |
| Example | 1 | Present | 25 | 42 | 1.5 | Satisfactory | 1.37.E+03 |
| Example | 33 | Present | 27 | 47 | 2.9 | Satisfactory | 1.10.E+03 |
| Example | 34 | Present | 27 | 42 | 5.0 | Satisfactory | 3.01.E+02 |

As shown in Table 4, even when changing the average grain size of the main phase grains, the temperature characteristics and the reliability were satisfactory. When the average grain size of the main phase grains was 0.5 μm or more and 3.0 μm or less, the reliability was particularly satisfactory.

### Experimental Example 5

With respect to Sample No. 1, an experiment was performed under the same conditions as in Experimental Example 1 except that the total content of Z2 was mainly changed. The relative contents between Mn, Si, and Al were set to be the same as in Sample No. 1. The results are shown in Table 5.

TABLE 5

| | | | | Entire Dielectric Layer | | | |
|---|---|---|---|---|---|---|---|
| | | | | Type of Z1 | Z1 | Type of Z2 | Z2 |
| Example/ | | | | (descending | Content | (descending | Content |
| Comparative | Sample | Perovskite-Type Compound | | order of | [parts by | order of | [parts by |
| Example | No. | A-site | B-site | content) | mole] | content) | mole] |
| Example | 41 | Ca_{0.70}Sr_{0.30} | Zr_{0.96}Ti_{0.03}Hf_{0.01} | W | 0.26 | Mn, Si, Al | 1.4 |
| Example | 42 | Ca_{0.70}Sr_{0.30} | Zr_{0.96}Ti_{0.03}Hf_{0.01} | W | 0.27 | Mn, Si, Al | 2.3 |
| Example | 1 | Ca_{0.70}Sr_{0.30} | Zr_{0.96}Ti_{0.03}Hf_{0.01} | W | 0.25 | Mn, Si, Al | 4.0 |
| Example | 43 | Ca_{0.70}Sr_{0.30} | Zr_{0.96}Ti_{0.03}Hf_{0.01} | W | 0.27 | Mn, Si, Al | 6.6 |
| Example | 44 | Ca_{0.70}Sr_{0.30} | Zr_{0.96}Ti_{0.03}Hf_{0.01} | W | 0.25 | Mn, Si, Al | 7.1 |

| | | Specific Main Phase Grains | | | Main | | |
|---|---|---|---|---|---|---|---|
| | | | | Area Ratio of | Phase | | |
| | | | | First | Grains | | |
| Example/ | | | Number | Microscopic | Grain | Characteristics | |
| Comparative | Sample | Present/ | Ratio | Region | Size | Temperature | MTTF |
| Example | No. | Absent | [%] | [%] | [um] | Characteristics | [h] |
| Example | 41 | Present | 24 | 39 | 1.2 | Satisfactory | 4.53.E+02 |
| Example | 42 | Present | 23 | 41 | 1.5 | Satisfactory | 1.50.E+03 |
| Example | 1 | Present | 25 | 42 | 1.5 | Satisfactory | 1.37.E+03 |
| Example | 43 | Present | 24 | 40 | 1.6 | Satisfactory | 1.05.E+03 |
| Example | 44 | Present | 23 | 38 | 1.7 | Satisfactory | 2.71.E+02 |

As shown in Table 5, even when changing the total content of Z2, the temperature characteristics and the reliability were satisfactory. When the total content of Z2 was 1.8 parts by mole or more and 7.0 parts by mole or less, the reliability was particularly satisfactory.

### Experimental Example 6

The kind of elements contained mainly as Z2 and/or the order of the contents thereof were changed from Sample No. 1. The results are shown in Table 6.

TABLE 6

| | | | | Entire Dielectric Layer | | | |
|---|---|---|---|---|---|---|---|
| | | | | Type of Z1 | Z1 | Type of Z2 | Z2 |
| Example/ | | | | (descending | Content | (descending | Content |
| Comparative | Sample | Perovskite-Type Compound | | order of | [parts by | order of | [parts by |
| Example | No. | A-site | B-site | content) | mole] | content) | mole] |
| Example | 51 | Ca_{0.70}Sr_{0.30} | Zr_{0.96}Ti_{0.03}Hf_{0.01} | W | 0.23 | Al, Si, Mn | 4.2 |
| Example | 52 | Ca_{0.70}Sr_{0.30} | Zr_{0.96}Ti_{0.03}Hf_{0.01} | W | 0.24 | Si, Mn, Al | 4.0 |
| Example | 1 | Ca_{0.70}Sr_{0.30} | Zr_{0.96}Ti_{0.03}Hf_{0.01} | W | 0.25 | Mn, Si, Al | 4.0 |
| Example | 53 | Ca_{0.70}Sr_{0.30} | Zr_{0.96}Ti_{0.03}Hf_{0.01} | W | 0.25 | Cr, Si, Al | 4.1 |

| | | Specific Main Phase Grains | | | Main | | |
|---|---|---|---|---|---|---|---|
| | | | | Area Ratio of | Phase | | |
| | | | | First | Grains | | |
| Example/ | | | Number | Microscopic | Grain | Characteristics | |
| Comparative | Sample | Present/ | Ratio | Region | Size | Temperature | MTTF |
| Example | No. | Absent | [%] | [%] | [um] | Characteristics | [h] |
| Example | 51 | Present | 26 | 44 | 1.8 | Satisfactory | 1.26.E+03 |
| Example | 52 | Present | 24 | 40 | 1.9 | Satisfactory | 1.31.E+03 |
| Example | 1 | Present | 25 | 42 | 1.5 | Satisfactory | 1.37.E+03 |
| Example | 53 | Present | 23 | 41 | 1.6 | Satisfactory | 1.37.E+03 |

As shown in Table 6, even when changing the kind of the elements contained as Z2, and/or the order of the contents thereof, the temperature characteristics and the reliability were satisfactory.

### Experimental Example 7

With respect to Sample No. 1, an experiment was performed under the same conditions as in Experimental Example 1 except that a raw material powder of the oxide of Z3 was added in combination with the Al₂O₃ powder and the SiO₂ powder. The results are shown in Table 7.

TABLE 7

| | | | | Entire Dielectric Layer | | | | | |
|---|---|---|---|---|---|---|---|---|---|
| | | | | Type ofZ1 | Z1 | Type ofZ2 | Z2 | Type of Z3 | Z3 |
| Example/ | | | | (descending | Content | (descending | Content | (descending | Content |
| Comparative | Sample | Perovskite-Type Compound | | order of | [parts by | order of | [parts by | order of | [parts by |
| Example | No. | A-site | B-site | content) | mole] | content) | mole] | content) | mole] |
| Example | 1 | Ca_{0.70}Sr_{0.30} | Zr_{0.96}Ti_{0.03}Hf_{0.01} | W | 0.25 | Mn, Si, Al | 4.0 | — | — |
| Example | 61 | Ca_{0.70}Sr_{0.30} | Zr_{0.96}Ti_{0.03}Hf_{0.01} | W | 0.26 | Mn, Si, Al | 4.0 | Mg | 1.0 |
| Example | 62 | Ca_{0.70}Sr_{0.30} | Zr_{0.96}Ti_{0.03}Hf_{0.01} | W | 0.24 | Mn, Si, Al | 4.2 | Li | 1.0 |
| Example | 63 | Ca_{0.70}Sr_{0.30} | Zr_{0.96}Ti_{0.03}Hf_{0.01} | W | 0.25 | Mn, Si, Al | 4.2 | B | 0.8 |
| Example | 64 | Ca_{0.70}Sr_{0.30} | Zr_{0.96}Ti_{0.03}Hf_{0.01} | W | 0.26 | Mn, Si, Al | 4.1 | P | 0.9 |

| | | Specific Main Phase Grains | | | Main | | |
|---|---|---|---|---|---|---|---|
| | | | | Area Ratio of | Phase | | |
| | | | | First | Grains | | |
| Example/ | | | Number | Microscopic | Grain | Characteristics | |
| Comparative | Sample | Present/ | Ratio | Region | Size | Temperature | MTTF |
| Example | No. | Absent | [%] | [%] | [um] | Characteristics | [h] |
| Example | 1 | Present | 25 | 42 | 1.5 | Satisfactory | 1.37.E+03 |
| Example | 61 | Present | 30 | 50 | 1.9 | Satisfactory | 1.48.E+03 |
| Example | 62 | Present | 23 | 39 | 1.7 | Satisfactory | 1.11.E+03 |
| Example | 63 | Present | 23 | 39 | 1.4 | Satisfactory | 1.18.E+03 |
| Example | 64 | Present | 30 | 50 | 1.9 | Satisfactory | 1.32.E+03 |

As shown in Table 7, even when further adding Z3, the temperature characteristics and the reliability were satisfactory.

### REFERENCE SIGNS LIST

1 multilayer ceramic capacitor
2 dielectric layer
3 inner electrode layer
4 outer electrode
10 element body
14 main phase grain
16 grain boundary

What is claimed is:

1. A dielectric ceramic composition comprising main phase grains and a grain boundary existing between the main phase grains,
wherein the main phase grains contain a perovskite-type compound as a main component,
the perovskite-type compound contains at least Ca as an A-site element and at least Zr as a B-site element,
the dielectric ceramic composition further comprises at least one selected from the group consisting of V, Nb, Ta, and W as a first additive element Z1,
the total content of Z1 with respect to 100 parts by mole of the B-site element is 0.005 parts by mole or more and 0.80 parts by mole or less,
at least a part of the main phase grains is composed of specific main phase grains,
each of the specific main phase grains includes a first microscopic region and a second microscopic region, at least a part of the first microscopic region is located at an outer peripheral portion, at least a part of the second microscopic region is located at a central portion, and a content of the first additive element Z1 with respect to 100 parts by mole of the B-site element in the second microscopic region is lower than that in the first microscopic region.

2. The dielectric ceramic composition according to claim 1, wherein a content of Z1 contained in the first microscopic region is 0.08 parts by mole or more in terms of oxide, with respect to 100 parts by mole in terms of oxide of the total content of all elements contained in the first microscopic region, and
a content of Z1 contained in the second microscopic region is less than 0.08 parts by mole in terms of oxide, with respect to 100 parts by mole in terms of oxide of the total content of all elements contained in the second microscopic region.

3. The dielectric ceramic composition according to claim 1 further comprising Si, Al, and at least one selected from the group consisting of Mn and Cr, as a second additive element Z2.

4. The dielectric ceramic composition according to claim 3, wherein the total content of Z2 with respect to 100 parts by mole of the B-site element is 1.8 parts by mole or more and 7.0 parts by mole or less.

5. The dielectric ceramic composition according to claim 3, wherein the total content of Mn and Cr in the dielectric ceramic composition is more than a content of Si, and a content of Si in the grain boundary is more than the total content of Mn and Cr.

6. The dielectric ceramic composition according to claim 3, wherein the total content of Ti, Mn, Cr, and Z1 with respect to 100 parts by mole of the B-site element is 8.0 parts by mole or less.

7. The dielectric ceramic composition according to claim 3, wherein the total content of Mn, Cr, and Z1 contained in the first microscopic region is 0.5 parts by mole or more in terms of oxide, with respect to 100 parts by mole in terms of oxide of the total content of all elements contained in the first microscopic region, and
the total content of Mn, Cr, and Z1 contained in the second microscopic region is less than 0.5 parts by mole in terms of oxide, with respect to 100 parts by mole in terms of oxide of the total content of all elements contained in the second microscopic region.

8. The dielectric ceramic composition according to claim 1, wherein the first microscopic region extends from the grain boundary toward the center of the specific main grain by a distance of at least one-fourth of an equivalent circle radius.

9. The dielectric ceramic composition according to claim 1, wherein a ratio of the number of the specific main phase grains to the number of the main phase grains is 10% or more and 95% or less.

10. The dielectric ceramic composition according to claim 1, wherein an area ratio of the first microscopic region in any cross-section is 20% or more and 95% or less.

11. The dielectric ceramic composition according to claim 1 further comprising at least one selected from the group consisting of Mg, Li, B, and P as a third additive element Z3.

12. The dielectric ceramic composition according to claim 1, wherein an average grain size of the main phase grains is 0.5 μm or more and 3.0 μm or less.

13. A multilayer ceramic electronic device comprising the dielectric ceramic composition according to claim 1.
